(19) United States
(12) Patent Application Publication
(10) Pub. No.: US 2004/0065705 A1
(43) Pub. Date: Apr. 8, 2004

(54) Surfboard carrying and mounting apparatus

(76) Inventor: Jonathan S. Shamrell, Newport Beach, CA (US)

Correspondence Address: Jonathan S. Shamrell, 39 Corsica, Newport Beach, CA, 92660, US

(21) Appl. No.: 10/266,287

(22) Filed: Oct. 7, 2002

(51) Int. Cl. B60R 9/00; B60R 7/00; B60R 11/00

(52) U.S. Cl. 224/319; 224/572

(57) ABSTRACT

A surfboard carrying and mounting apparatus comprising a first rectangular strip attached to a second rectangular strap having a plurality of loops is disclosed. The second rectangular strap has a side release snap faster at a fixed end and extends beyond the first rectangular strip at a free end. The first rectangular strip is placed on the surfboard and the second rectangular strap is wrapped around the surfboard wherein the free end is placed through the side release snap faster for tightening and securing the first rectangular strip to the surfboard. A plurality of attachment straps with cam buckles and having carabiners at each end are placed through the plurality of loops and around the roof rack of an automobile. The carabiners are hooked together wherein the cam buckles are used for tightening the attachment straps for securing the surfboard to the roof rack of the automobile.

### BACKGROUND OF THE INVENTION

I. Field of the Invention

The present invention relates generally to carrying devices for recreational sporting equipment. More particularly, the present invention is directed to a novel and improved apparatus for carrying and mounting surfboards and sporting equipment.

II. Description of the Related Art

A surfboard is made up of fiberglass and foam. It is a very fragile piece of equipment and can be damaged extremely easily. Fiberglass is sensitive to pressure, stress and heat. The fins on a surfboard are also very sensitive to stress and can snap with ease. A surfer has various needs for safekeeping the board during both storage and traveling. When a surfer is traveling by car, the board can be stored on top of the car using a surfboard rack. There are various types of car racks, but the most common racks for cars are usually either “hard racks” (permanent metal racks) or “soft racks” (portable padded racks). The board racks work by strapping the board to the padded rack on top of the vehicle.

Another need when owning a surfboard is safely storing the board while idle. There are various ways to store a surfboard, but the most popular seems to be the wall rack. The wall rack is made up of two “L” shaped, padded arms that screw into the wall. The board is then placed on the arms of the wall rack and is held suspended off the ground. One major problem with the wall rack is that it sticks out from the wall (about three feet) and it does not necessarily keep the board clean or safe from damage.

In the past, all of these needs have been met by acquiring different products, one for storing the surfboard, one for carrying the surfboard and one for mounting the surfboard on the roof of a car. What is needed is a low-cost, easy to manufacture surfboard carrying and mounting apparatus which is easy to use, easy to store, wall/ceiling rack and vehicle transportation rack all in one product. The present invention fulfills these needs and many others.

### SUMMARY OF THE INVENTION

A surfboard carrying and mounting apparatus comprising a first rectangular strip attached to a second rectangular strap having a plurality of loops is disclosed. The second rectangular strap has a side release snap faster at a fixed end and extends beyond the first rectangular strip at a free end. The first rectangular strip is placed on the surfboard and the second rectangular strap is wrapped around the surfboard wherein the free end is placed through the side release snap faster for tightening and securing the first rectangular strip to the surfboard. A plurality of attachment straps with cam buckles and having carabiners at each end are placed through the plurality of loops and around the roof rack of an automobile. The carabiners are hooked together wherein the cam buckles are used for tightening the attachment straps for securing the surfboard to the roof rack of the automobile.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 is a side view of the surfboard mounting apparatus in accordance with the present invention;

FIG. 2 is a side view of an attachment strap to be used in accordance with the present invention;

FIG. 3A is a top plan view of the surfboard mounting apparatus of FIG. 1;

FIG. 3B is a close-up view of FIG. 3A detailing the construction of the surfboard mounting apparatus;

FIG. 4A is a side view showing the installation of the surfboard mounting apparatus to a roof rack of an automobile;

FIG. 4B is a close-up view of one of the attachment straps of the present invention; and

FIG. 5 is a top plan view showing the installation of the surfboard mounting apparatus to the roof rack of the automobile.

### DETAILED DESCRIPTION OF THE PREFERRED EMBODIMENT

The present invention will now be described with reference numerals corresponding to like parts throughout the drawings. The present invention is adaptable, without departing from the spirit of the invention, to carry almost all types of recreational equipment. Referring now to FIGS. 1, 3A and 3B, a surfboard carrying and mounting apparatus 10 comprising a first elongated rectangular strip 8 having a top portion 16 attached to a bottom pad 18 is shown. The top portion 16 is preferably made from a cloth material and the bottom pad 18 made from a flexible material, for example neoprene so as not to damage the surfboard when mounting to the roof rack of a car, as will be more fully described below. In one embodiment, the top portion 16 is attached to the bottom pad 18 by stitching the two together.

A second elongated rectangular strap 12 is attached to the top portion 16 of the first elongated rectangular strip. In one embodiment, the second strap 12 is made from nylon that may be approximately one inch in width and is stitched to the cloth top portion 16 of the rectangular strip 8. The second elongated rectangular strap 12 has a side release snap faster 20 at a fixed end and extends beyond the first elongated rectangular strip 8 at a free end 30. A plurality of loops 14 are stitched to the second nylon strap 12 and are spaced along the first elongated rectangular strip 8. In use, the flexible bottom pad 18 is placed on the surfboard (not shown) with the second elongated rectangular strap 12 wrapped around the surfboard. The free end 30 is then placed through the side release snap faster 20 for tightening and securing the first elongated rectangular strip 8 to the surfboard whereby the plurality of loops 14 may be used to wall mount the surfboard.

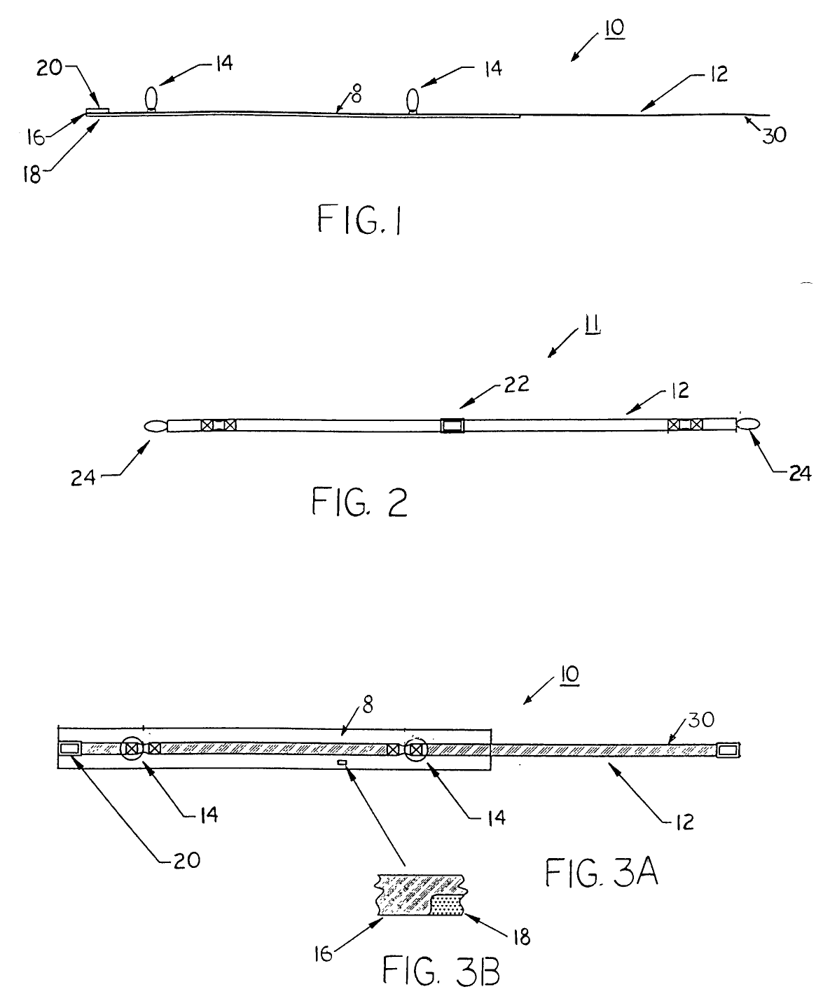

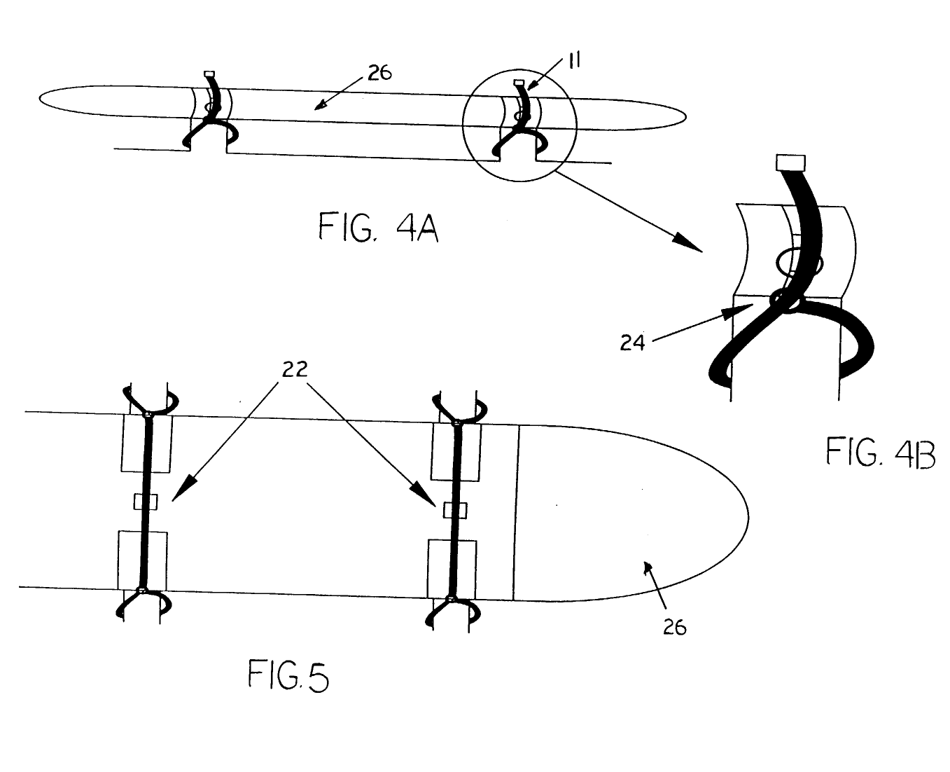

Referring now to FIGS. 2A, 4A-B and 5 an attachment strap 11 is shown for use in mounting the surfboard attachment device 10 to the roof rack of an automobile. The attachment strap 11 has carabiners 24 at each end and a cam buckle 22 attached thereto. In use a plurality of attachment straps 11 are placed through the plurality of loops and around the roof rack of an automobile. The carabiners 24 are hooked together and the cam buckles 22 are used for tightening the attachment straps 11 for securing the surfboard 26 to the roof rack of the automobile. The attachment straps 11 are preferably made from nylon and in one embodiment may be one inch in width. Additionally, the attachment straps 11 may be made from two parts of nylon with the cam buckle used to connect the two parts for tightening the straps 11 when mounting the surfboard 26 to the roof rack.

The previous description of the preferred embodiments is provided to enable any person skilled in the art to make or use the present invention. The various modifications to these embodiments will be readily apparent to those skilled in the art, and the generic principles defined herein may be applied to other embodiments without the use of the inventive faculty. Thus, the present invention is not intended to be limited to the embodiments shown herein but is to be accorded the widest scope consistent with the principles and novel features disclosed herein.

1. A surfboard carrying and mounting apparatus comprising:
a first elongated rectangular strip having a top portion attached to a bottom pad;
a second elongated rectangular strap attached to said top portion of said first elongated rectangular strip; said second elongated rectangular strap having a side release snap faster at a fixed end and extending beyond said first elongated rectangular strip at a free end and having a plurality of loops spaced along said first elongated rectangular strip wherein said flexible bottom pad is placed on the surfboard and said second elongated rectangular strap is wrapped around the surfboard wherein said free end is placed through said side release snap faster for tightening and securing said first elongated rectangular strip to the surfboard whereby said plurality of loops may be used to wall mount the surfboard.

2. The surfboard carrying and mounting apparatus of claim 1 further comprising:
a plurality of attachment straps, said attachment straps having carabiners at each end and cam buckles attached thereto, and
said plurality of attachment straps being placed through said plurality of loops and around the roof rack of an automobile, wherein said carabiners are hooked together and said cam buckles are used for tightening said attachment straps for securing the surfboard to the roof rack of the automobile.

3. The surfboard carrying and mounting apparatus according to claim 1 wherein said top portion is made from cloth.

4. The surfboard carrying and mounting apparatus according to claim 3 wherein said bottom pad is made from neoprene.

5. The surfboard carrying and mounting apparatus according to claim 4 wherein said second elongated strap is made from nylon and is stitched to said cloth top portion.

6. The surfboard carrying and mounting apparatus according to claim 5 wherein said cloth top portion is stitched to said neoprene bottom portion.

7. The surfboard carrying and mounting apparatus according to claim 1 further wherein said first elongated rectangular strip and said second elongated rectangular strap are made from durable all weather material.

8. The surfboard carrying and mounting apparatus according to claim 6 wherein said plurality of loops are steel loops are attached to said second elongated strap by stitching nylon strips through said loops to said second elongated strap.

9. The surfboard carrying and mounting apparatus according to claim 2 wherein said plurality of attachment straps are made of nylon.

10. The surfboard carrying and mounting apparatus according to claim 9 wherein said attachment straps are two strips of nylon coupled together with said carabiner.

11. The surfboard carrying and mounting apparatus according to claims 1 and 2 wherein said second rectangular strap and said plurality of attachment straps are approximately one inch in width.

12. A surfboard mounting apparatus for mounting to the roof rack of an automobile, comprising:
a first elongated rectangular strip having a top portion attached to a bottom pad;
a second elongated rectangular strap attached to said top portion of said first elongated rectangular strip; said second elongated rectangular strap having a side release snap faster at a fixed end and extending beyond said first elongated rectangular strip at a free end and having a plurality of loops spaced along said first elongated rectangular strip wherein said flexible bottom pad is placed on the surfboard and said second elongated rectangular strap is wrapped around the surfboard wherein said free end is placed through said side release snap faster for tightening and securing said first elongated rectangular strip to the surfboard; and
a plurality of attachment straps, said attachment straps having carabiners at each end and cam buckles attached thereto; said plurality of attachment straps being placed through said plurality of loops and around the roof rack of an automobile, wherein said carabiners are hooked together and said cam buckles are used for tightening said attachment straps for securing the surfboard to the roof rack of the automobile.

13. The surfboard carrying and mounting apparatus according to claim 12 wherein said top portion is made from cloth.

14. The surfboard carrying and mounting apparatus according to claim 13 wherein said bottom pad is made from neoprene.

15. The surfboard carrying and mounting apparatus according to claim 14 wherein said second elongated strap is made from nylon and is stitched to said cloth top portion.

16. The surfboard carrying and mounting apparatus according to claim 15 wherein said cloth top portion is stitched to said neoprene bottom portion.

17. The surfboard carrying and mounting apparatus according to claim 16 wherein said plurality of loops are steel loops are attached to said second elongated strap by stitching nylon strips through said loops to said second elongated strap.

18. The surfboard carrying and mounting apparatus according to claim 17 wherein said plurality of attachment straps are made of nylon.

19. The surfboard carrying and mounting apparatus according to claim 18 wherein said attachment straps are two strips of nylon coupled together with said carabiner.

12. A surfboard mounting apparatus for mounting to the roof rack of an automobile, comprising:
a first elongated rectangular strip having a top cloth portion attached to a bottom neoprene pad;
a second elongated rectangular nylon strap attached to said top cloth portion of said first elongated rectangular strip; said second elongated rectangular strap having a side release snap faster at a fixed end and extending beyond said first elongated rectangular strip at a free end and having a plurality of metal loops spaced along said first elongated rectangular strip wherein said flexible bottom neoprene pad is placed on the surfboard and said second elongated rectangular nylon strap is wrapped around the surfboard wherein said free end is placed through said side release snap faster for tightening and securing said first elongated rectangular strip to the surfboard; and
a plurality of attachment nylon straps, said attachment nylon straps having carabiners at each end and cam buckles attached thereto; said plurality of attachment nylon straps being placed through said plurality of metal loops and around the roof rack of an automobile, wherein said carabiners are hooked together and said cam buckles are used for tightening said attachment nylon straps for securing the surfboard to the roof rack of the automobile.
